(19) United States
(12) Patent Application Publication
(10) Pub. No.: US 2005/0035136 A1
(43) Pub. Date: Feb. 17, 2005

(54) Food distribution system

(76) Inventors: Paul Dathe, Plymouth, MN (US); Dion L. Kells, Norwood, MN (US)

Correspondence Address: DORSEY & WHITNEY LLP;INTELLECTUAL PROPERTY DEPARTMENT, 50 SOUTH SIXTH STREET, MINNEAPOLIS, MN, 55402-1498, US

(21) Appl. No.: 10/617,425

(22) Filed: Jul. 11, 2003

(51) Int. Cl. B65H 5/28; G07F 11/68

(52) U.S. Cl. 221/71

(57) ABSTRACT

A system for providing food items in conjunction with eating utensils. The system comprises a food display unit proximate a point of sale and a eating utensil dispenser associated with the food display unit. The food display unit includes a shelf for displaying the food items. The eating utensil dispenser includes a housing and a attachment device for coupling the housing to the food display unit. The housing has an opening therethrough and a cavity in communication with the opening. The cavity is adapted to receive a bandolier of individually wrapped eating utensils, and the eating utensils are dispensed through the opening.

### BACKGROUND OF THE INVENTION

1. Field of the Invention

The present invention relates generally apparatus and methods for dispensing food products, eating utensils, and seasoning or topping packets.

2. Description of the Related Art

In recent years, people have become more health conscious and more concerned about what foods they consume. At the same time, people continue to be more active and have less time to obtain and prepare healthy food choices for themselves and for their children. Thus, there tends to be a conflict between convenience and healthy food choices. For example, typical “fast food” outlets can provide fast, inexpensive and complete meals for a person or for a family; however, the food offered tends to be high in fat and extremely high in calories.

The same considerations are true for snacks or small meals. Consumers on the run will often grab a snack while at a point of sale (e.g., a cash register in a grocery store or any type of business) as a matter of convenience. Likewise parents may choose to purchase a snack or their children may request or demand such a snack when presented with the choices at the point of sale. The food choices commonly available at a point of sale are generally limited. Often, there is a wide selection of candy, chips, gum and more recently soda that is chilled in a cooler conveniently located near the point of sale.

The choice of products placed at the point of sale are based on a number of factors. The first is convenience. Candy and the like can be stored in bulk at room temperature, can be readily stocked and displayed, and can be quickly identified by the consumer. The second factor is inducement. That is, retailers will place items at the point of sale that are likely to trigger impulse purchases. For example, children will see candy and ask for it from their parents. People purchasing other products will see tempting food choices and partake. Another factor is serving the perceived convenience of the consumer. That is, providing last minute items people may typically want or need but often forget (e.g., batteries). Finally, people who are hungry and looking for a snack will choose from what is presented. That is, whatever is conveniently presented to them at the point of sale becomes their menu from which to choose.

Another factor, related to convenience is the readiness of the food choice for consumption. As our society demands greater convenience and becomes increasingly mobile, there has been an upsurge in the number and types of food packages that customers can consume “on the go” or when it is otherwise inconvenient for a consumer to sit down and ingest a meal in what society may view as a conventional setting (i.e., sitting down around a table).

Candy, chips, and similar items are sold in individual, single serve packages. The consumer can obtain them and they are instantly ready to be consumed. Retailers will choose to present items at the point of sale based on what they perceive the consumers to ultimately want based on past sales success, while meeting the other factors noted above.

With the above taken into consideration, various manufacturers of food products strive to present food choices that are desirable to consumers and meet the various factors for convenience. Such food choices include pudding, applesauce, JELL-O®, yogurt, ice cream, soup, and other food products. For example, pudding, applesauce, JELL-O®, ice cream, soup, and yogurt are already available in convenient, single serve containers that can be purchased individually. Historically, these products have not been offered at the point of sale or extensively touted as a convenience snack or meal. This is because some food products (e.g., ice cream, JELL-O®, yogurt) need refrigeration for preservation until sold. Also, in most cases, the aforementioned food products require an eating utensil (e.g., a spoon, fork, spork) in order to be consumed.

With the recent popularity of providing soda and other chilled liquid items at the point of sale, the refrigeration issue becomes moot. That is, convenient and properly sized refrigeration units are readily available and are already in use in many places. Thus, the remaining consideration is eating utensil delivery. Obviously, to truly be a food of convenience, eating utensils must be provided to the consumer with the purchase of the product.

One regional brand of yogurt, COLOMBO®, has provided a spoon that is incorporated into the top of a single serve yogurt container. While this is certainly convenient from the standpoint of providing the spoon to the consumer, this concept suffers in other ways. That is, in order to be so packaged the spoon must necessarily be very small. This makes it difficult to manipulate the spoon; both for assembly and for product consumption. Once assembled, consumers may have a difficult time keeping the spoon together. Furthermore, the small spoon requires that only small quantities of yogurt be delivered to the mouth. With the spoon being so small, it is also difficult to reach the bottom of the container. Finally, this particular brand of yogurt is not available in all areas and even when available consumers are limited to only that brand and particular product line if they wish to receive the incorporated spoon.

Another possible solution would be to place a container of standard one-piece plastic spoons near the display: of food products. Such spoons could be individually wrapped or unwrapped. In either case, there are several drawbacks. The cost for such spoons is increased because they are full size. It becomes harder to fill the container because the spoons tend to bridge. Finally, people will likely take the spoons for other reasons (e.g., employees taking a break) or other uses. That is, full size spoons are desirable for many reasons and will be taken accordingly. Thus, it becomes even more difficult to maintain a full container.

Thus, there exists a need to provide a mechanism for providing yogurt, pudding, applesauce, JELL-O®, ice cream, soup, and the like as a convenience food item. There further exists a need to provide a mechanism for dispensing eating utensils for use to consume the food products. There also exists a need to provide a simple, convenient mechanism for dispensing 3-D eating utensils.

### BRIEF SUMMARY OF THE INVENTION

The present invention includes, in one embodiment, the placement of a refrigerated unit at or near the point of sale in a business setting, such as a grocery store. Individual containers containing a food product (e.g., a comestible container) are stocked and displayed within a refrigerated unit. In one embodiment, the comestible container may contain food products such as ice cream, yogurt, JELL-O®, pudding, soup, etc. Thus, consumers at a point of sale see and are tempted by a food choice that is alternative to the candy and pop traditionally offered at the point of sale. Furthermore, those consumers seeking out such alternatives are aided in a convenient manner. The consumer can simply select one or more comestible containers for consumption.

In one embodiment, eating utensils, such as spoons, forks, sporks, knives, chopsticks, and/or straws, are dispensed from a dispenser that is attached to a price facing of the shelf displaying the food product. This arrangement can be used when the food product is displayed at the point of sale or when displayed in the more traditional locations, for example, yogurt or ice cream in a dairy case. The dispenser fits below the shelf so as to minimize its intrusiveness and reduce the amount of space taken from stocking the food item. An attachment mechanism is provided so that the dispenser attaches to points along the price facing. This prevents the dispenser from obscuring food item products and from significantly obscuring the displayed pricing information.

The dispenser is loaded with a bandolier of eating utensils such as spoons, forks, sporks, knives, chop sticks, and/or straws. The bandolier has a plurality of individually sealed eating utensils that are provided in plastic satchels that are interconnected. A perforation or other point of separation is provided so that the eating utensils can be easily separated. The bandolier is loaded and the first eating utensil is guided through an opening in the dispenser. In one embodiment, a tab is provided that separates one satchel from the next as the consumer pulls the lead eating utensil.

In one embodiment, the eating utensils, such as spoons, forks, sporks, knives, chop sticks or straws, dispensed by the dispenser are full size eating utensils. In another embodiment, the eating utensils dispensed by the dispenser are reduced size eating utensils.

In another embodiment, the eating utensils, such as spoons, forks, or sporks, have two sections that are hinged together. Thus, for storage within the satchel of the bandolier, the spoon, fork or spork is folded in half to minimize space. When in use, the spoon, fork or spork is unfolded to its maximum length. A hinge tab snaps into a hinge slot securing the spoon, fork or spork in the open position. The arrangement of the tab and slot is such that as pressure is applied to the spoon, fork or spork during use (e.g., scooping yogurt) the tab and slot are further engaged. That is, to disengage the tab and slot, force must be applied in a direction opposite to that provided during normal use of the spoon, fork or spork.

The present invention, in one embodiment, is a method of providing a refrigerated or frozen food item (e.g., ice cream, yogurt, etc.). The method includes providing a refrigerated unit proximate a point of sale and providing individual containers of refrigerated or frozen food within the refrigerated unit.

In another embodiment, the present invention is a method of providing a food product (e.g., yogurt, ice cream, soup, applesauce, etc.) on the go. The method includes providing a refrigerated display case proximate a point of sale, the display having at least one shelf and stocking a food product within the refrigerated display. The method also includes providing a dispenser coupled to the at least one shelf, wherein the dispenser includes a cavity and an opening and providing a bandolier of individually wrapped foldable eating utensils (e.g., spoons, forks, sproks). The method further includes storing the bandolier within the cavity so that a first end of the bandolier is fed through the opening so that the eating utensil can be dispensed.

In another embodiment, the present invention is a eating utensil dispenser. The eating utensil dispenser includes a housing, a cavity within the housing for receiving a bandolier of individually wrapped items, an opening through the housing in communication with the cavity, and an attachment bracket for coupling the housing to a price shelf of a shelving unit.

In another embodiment, the present invention is a system for providing food items on the go. The system includes a dispenser having a housing with an internal cavity and an opening in communication the internal cavity and an attachment bracket coupleable with the dispenser so that the dispenser may be supported from a price shelf of a food item display. The system also includes a bandolier of individually wrapped plastic eating utensils (e.g., spoons, forks, sporks, knives, chop sticks, straws), wherein the bandolier is receivable within the cavity so that a first end of the bandolier is guided through the opening.

In another embodiment, the present invention includes dispensing seasoning packets or packets with topping through a bandolier for use with a food product (e.g., yogurt, ice cream, soup, applesauce, etc.) on the go.

In another embodiment, the present invention includes a method for providing free samples. That is, a system of the present invention would include one or more bandoliers with utensils and/or seasoning or topping packets to be used with the food product (e.g., yogurt, ice cream, soup, applesauce, etc.) that customers may try prior to buying the food product.

While multiple embodiments are disclosed, still other embodiments of the present invention will become apparent to those skilled in the art from the following detailed description, which shows and describes illustrative embodiments of the invention. As will be realized, the invention is capable of modifications in various obvious aspects, all without departing from the spirit and scope of the present invention. Accordingly, the drawings and detailed description are to be regarded as illustrative in nature and not restrictive.

### BRIEF DESCRIPTION OF THE DRAWINGS

FIG. 1 is a schematic illustration of a food display unit having a food item and an associated eating utensil dispenser provided in proximity to a point of sale.

FIG. 1a is a schematic illustration of a food display unit having a food item, an associated eating utensil dispenser, and an associated microwave oven provided in proximity to a point of sale.

FIG. 2. is a perspective view of a food item shelf with an associated eating utensil dispenser.

FIG. 3 is an illustration of a bandolier of eating utensils suitable for placement into the dispensers of FIG. 1 or 2.

FIG. 4 is a perspective view of the eating utensil dispenser of FIG. 1 or 2 with a bandolier of eating utensils loaded therein and a number of eating utensil satchels expelled from an opening in the dispenser.

FIG. 5 is a top planar view of a portion of a bandolier of eating utensils illustrating the interconnection of individual satchels.

### DETAILED DESCRIPTION

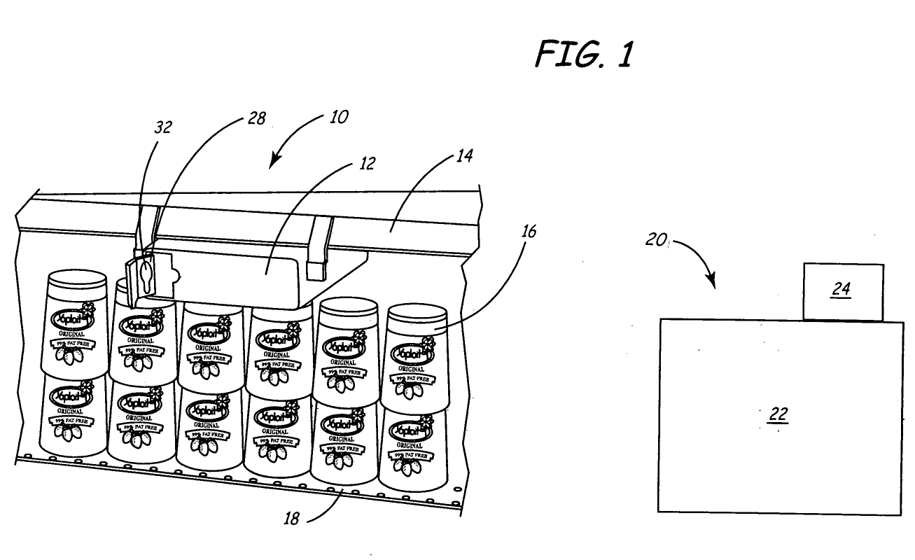

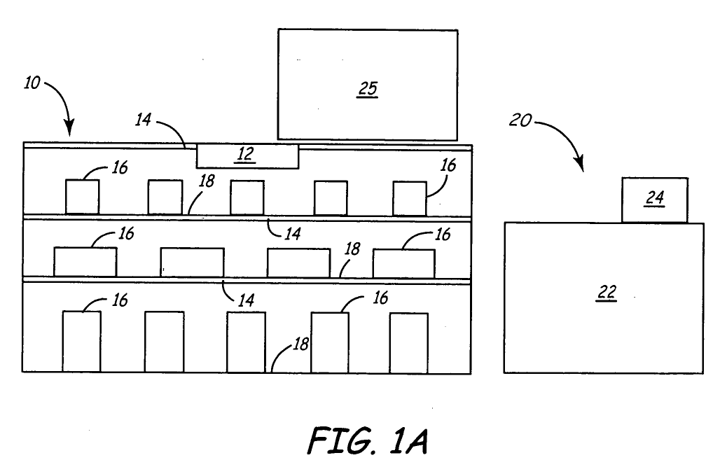

FIG. 1 illustrates a food display unit 10 having a plurality of food items 16 (e.g., containers of yogurt, ice cream, pudding, soup, applesauce, JELLO®, salads, etc.) displayed on a shelf 18. A dispenser 12 is attached to a price facing 14 of the shelf 18 and is stocked with a bandolier 28 of plastic eating utensils 2 (e.g., spoons, forks, sporks, knives, chop sticks, straws). The food display unit 10 is proximate a point of sale, such as checkout lane 20. Checkout lane 20 includes a checkout counter 22 and a register 24.

In one embodiment, the food display unit 10 is a refrigerator unit where the food items 16 displayed, such as yogurt, salads, and JELLO®, require refrigeration. In one embodiment, the food display unit 10 is a freezer unit where the food items 16 displayed, such as ice cream, sherbet, etc., need to be maintained in a frozen state. In one embodiment, the food display unit 10 includes a heating unit (such as a microwave, see FIG. 1a) where the food items 16 displayed, such as soup, stew, pizza, stir-fry, etc., may be heated. Alternatively, the food display unit 10 may have the heating unit integrated within the display to maintain the food items 16 in a heated state. This can be accomplished through heat lamps, electric heating plates, hot water baths, or other means know in the art for maintaining food in a heated state. In one embodiment, the food display unit 10 is simply a set of display shelving without refrigeration or heating. This is used where the food items 16 displayed, such as pudding, applesauce, etc., do not require refrigeration or heating.

In one embodiment, as depicted in FIG. 1a, the food display unit 10 and a microwave oven 25 are provided proximate the point of sale, such as a checkout lane 20 with a checkout counter 22 and a register 24. In other embodiments, other suitable heating mechanisms (e.g., electric or gas fired ovens or stove tops, etc.) may be substituted for the microwave oven.

The food display unit 10 is stocked with food items 16 that are microwaveable (e.g., soup, stew, pizza, burritos, etc.). A customer removes a microwaveable food item 16 from the food display unit 10 and places the food item 16 in the microwave oven 25 for heating.

A dispenser 12 is attached to a price facing 14 of the shelf 18, the top or side of the food display unit 10, or the top or side of the microwave oven 25. In one embodiment, the dispenser 12 is stocked with a bandolier 28 of plastic eating utensils 2 (e.g., spoons, forks, sporks, knives, chop sticks, straws). In another embodiment, the dispenser 12 may be stocked with season packets or packets containing toppings for use with a food product. In order to facilitate having utensils and toppings/seasoning packets for use by a consumer, one or more dispensers 12 may be attached to the price facing 14 of the shelf 18. Thus, when the customer approaches the point of sale, he or she has immediate, easy access to everything needed for a hot or warm meal (i.e., the food item 16, seasoning packets, the means of heating the food item 25, and the eating utensil 2).

By providing a food display unit 10 stocked with food items 16 and eating utensils 32 proximate the point of sale, food items 16, such as yogurt, ice cream, soup, stews, stir-fry, applesauce, pudding, salads, etc., become foods of convenience. For example, in one embodiment, where the food item 16 is yogurt, this concept is referred to as “yogurt on the go”. That is, yogurt becomes a choice for consumers looking for a fast, convenient, simple, ready-to-eat food product. Everything the consumer needs is placed in a convenient location; the yogurt product is chilled in an easily accessible, highly visible cooler and spoons 32 are conveniently provided right alongside the yogurt. There is no need to search for an eating utensil elsewhere. In one embodiment, the spoons are customized for use with the yogurt container, but are not limited to one type, style or brand of yogurt. That is, because the spoons are individually and separately distributed, any type or combination of yogurt products can be stocked in the food display unit 10, which in the context of yogurt would be a refrigeration unit. Furthermore, this convenience is provided without requiring a modification to the yogurt container. Also, a dispenser 12 with topping packets may be included to allow a customer to add toppings to the yogurt.

This arrangement satisfies the criteria for both the consumer and the seller, as discussed above. That is, with the combination of yogurt at the point of sale and the present spoon and spoon dispenser, yogurt becomes a food of convenience. This arrangement is easy to stock, may trigger impulse purchases, will satisfy those consumers simply seeking convenient foods, will cater towards those looking to make healthy choices, and allows parents to satisfy children's requests with a healthy food product.

These and other benefits will often also be realized when the dispenser and spoons are located near traditional yogurt selling points (e.g., the dairy case). Thus, for purposes of the present invention the use and placement of the yogurt display (e.g., stocked product), the dispenser 12, and the spoons can occur anywhere. However, as described an additional set of advantages is realized when the yogurt on the go concept is utilized proximate the point of sale.

The “yogurt on the go” concept has been provided as one example of making a food item and an eating utensil available in close proximity to a point of sale. Those skilled in the art will realize that the concept can be readily adapted to other food items (e.g., ice cream, soup, pudding, JELLO®, applesauce, salads, stir-fry, etc.), other eating utensils (e.g., forks, sporks, knives, chop sticks), and other food display units 10 (e.g., freezer units, heating units, and simple food display shelves that are neither refrigerated nor heated). Thus, the invention should not be limited to the “yogurt on the go” concept.

As used herein, a food display unit 10 is proximate the point of sale when that food display unit 10 is visible from and can be accessed by a consumer when that consumer is accessing, waiting to access, or approaching the point of sale. In many retail locations, there will be multiple checkout counters. Each such counter may be considered a point of sale and have its own merchandise displayed. The present invention also encompasses the concept wherein one or more food display units 10 are proximate one or more of these checkout counters, but may be disposed to benefit multiple checkout counters. For example, a food display unit 10 may be centered along a line of checkout lanes. Thus, the food display unit 10 will certainly be closer to some checkout lanes than to others, however it would still be considered proximate the point of sale.

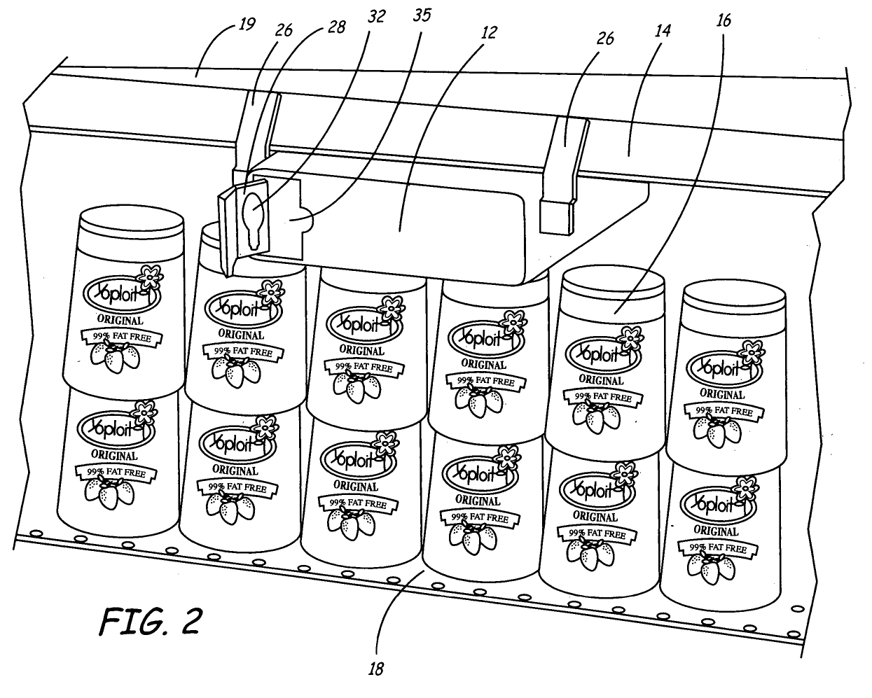

FIG. 2 illustrates the dispenser 12 as it is affixed to the price facing 14 either within the food display unit 10 or at any display shelf (e.g., a refrigerated shelf at the dairy case or a freezer shelf in a freezer). The dispenser 12 may be formed from plastic using any known manufacturing technique, such as injection molding the component parts. The dispenser 12 includes a hollow interior cavity for storing a bandolier 28 of eating utensils 32 (e.g., spoons, forks, sporks, knives, straws, chop sticks). Various guide mechanisms (not shown) may be located within the cavity for holding and guiding the bandolier 28 as it is stored and ultimately withdrawn.

A dispenser opening 35 is provided that is in communication with the cavity. One end of the bandolier 28 is guided out of the cavity through the dispenser opening 35 so that individual eating utensil packets (or individual seasoning or topping packets) 30 can be accessed and removed. A tab or tearing mechanism (not shown), such as a forked prong, may be provided that allows the user to index an eating utensil packet 30 and engage a portion of the bandolier 28 so that the bandolier 28 is caused to tear or separate allowing that eating utensil packet 30 to be taken.

The dimensions of the dispenser 35 are selected to accommodate the bandolier. That is the interior height of the cavity must accommodate the height of the bandolier 28 positioned within. The width and length are similarly chosen to accommodate the linear dimensions of the full bandolier roll. Alternatively, the dispenser can be configured to receive a plurality of bandoliers 28 and will be sized accordingly.

Another consideration for the configuration of the dispenser 35 is the minimization of the intrusion into the shelf space allotted for the food item 16. As such shelf space is valuable, it is desirable to limit or eliminate the need to stock less food items 16 because of the dispenser 35. As illustrated, the dispenser 35 tucks conveniently below a shelf 19, so that if the space between shelves 18 and 19 are configured as shown, no loss of product space results. That is, there is an existing gap between the stacked food items 16 and the shelf 19 that would have been unused but for the dispenser 36.

Similarly, just as it is desirable to prevent the dispenser from taking space away from the product, it is desirable to minimize the effect the dispenser 35 will have in obscuring information presented on the price facing 14 (i.e., the front or exposed edge of shelf 19). The price facing 14 is commonly used to receive tags indicating the type and price of the product displayed above or below the price facing 14. As illustrated, a pair of attachment brackets 26 are coupled with and support the dispenser 12. The attachment brackets 26 engage and are supported by the price facing 14. The attachment brackets are relatively narrow in comparison to the dispenser 12. Thus, only a relatively small space along the price facing 14 is taken. The front or exposed portions of the attachment brackets 26 and the dispenser 12 could receive advertisements or other printed matter. The attachment brackets 26 have a configuration that allows them to be snapped into opposed edges of the price facing 14 and held in place. Other attachment mechanisms such as adhesives, magnets, or mechanical fasteners (e.g., bolts, screws, clips, etc.) could be used to secure the attachment brackets 26 to the price facing 14.

The arrangement of the dispenser 12 and the attachment brackets 26 is such that it may be retrofitted to existing shelving units 18, 19 in a quick and simple manner while minimizing any negative impact to that shelf space. Such a dispenser 12 could be configured to be a standard component of new shelving. Alternatively, other attachment mechanisms can be utilized to provide dispenser 12 in close proximity to the food item 16.

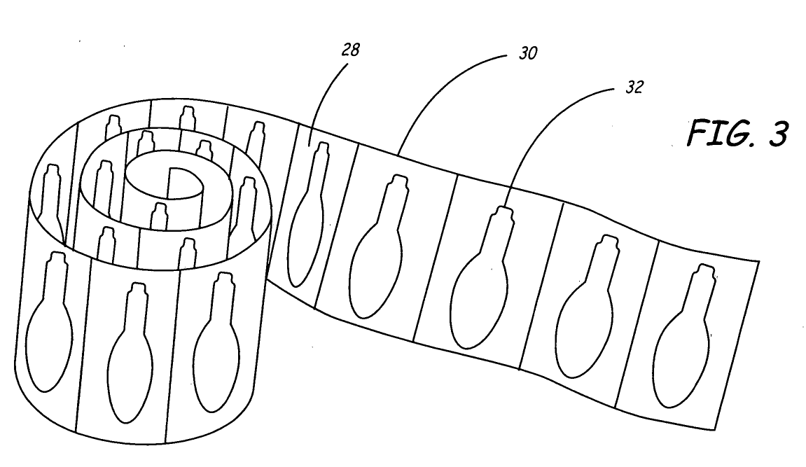

FIG. 3 illustrates a partially unrolled bandolier 28 of vertically arranged eating utensil packets 30. Each eating utensil packet 30 includes an individual eating utensil 32 and each packet 30 is separable. The process for producing a bandolier 28 of individual, separable items is disclosed in U.S. Pat. No. 5,752,365 issued to Johnson et al. on May 19, 1998, which is herein incorporated by reference in its entirety. As illustrated, the rolled bandolier 28 in this embodiment is circular and is accommodated within the cavity of the dispenser 12 for this embodiment.

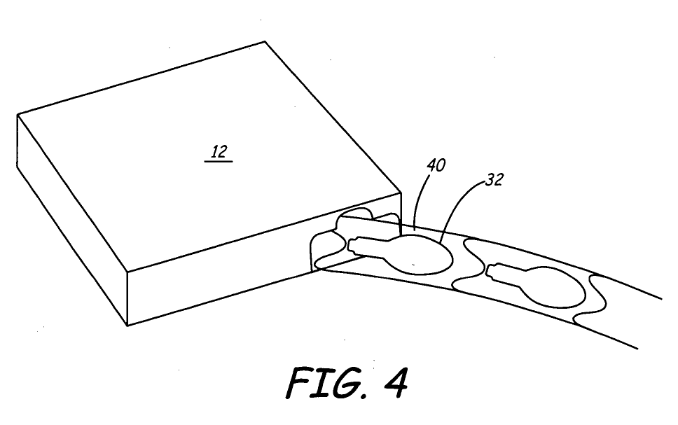

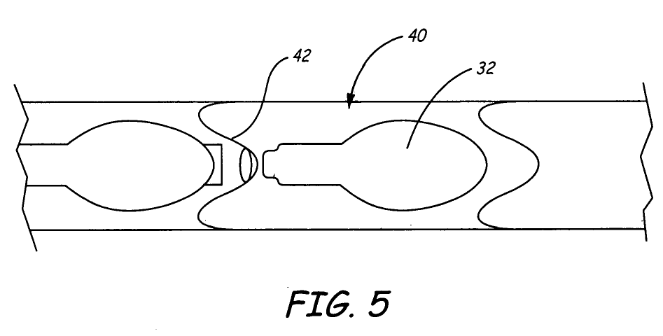

In both FIGS. 2 and 3, the illustrated bandolier 28 and resulting eating utensil packets 30 are vertically oriented. That is, the eating utensils 32 are arranged side to side. FIGS. 4 and 5 illustrates a horizontal bandolier 40, which is substantially identical to bandolier 28, except that the eating utensils 32 are arranged horizontally or rather, end to end. This arrangement may make it easier for a consumer to grab and separate an individual eating utensil packet 30. In addition, a perforation 42 between adjacent packets 30 can be configured around the curvature of the eating utensil 30. This curved perforation 42 is well suited to be engaged by a tab or separation member located on the dispenser 12 to assist in tearing or separating one eating utensil packet 30 from another.

In one embodiment, the dispenser 12 dispenses full size eating utensils, such as spoons, forks, sporks, knives, chop sticks, and straws. In one embodiment, the dispenser 12 dispenses reduced size eating utensils. In another embodiment, a dispenser 12 is full of seasoning/topping packets.

In one embodiment, the dispenser dispenses folded utensils. For example, the bandolier 28, 40 contains folded eating utensils, such as a spoons, forks or sporks. In one embodiment, the foldable eating utensil has a handle coupled to a head. The head is a bowl in the context of a spoon or spork, while the head is a set of tangs in the context of a fork.

The handle of the eating utensil is hinged via a hinge at approximately the longitudinal midpoint of the eating utensil. Thus, in its folded configuration, the eating utensil's length is approximately half of its unfolded length.

In order to keep the eating utensil secured in the closed position, a locking tab and locking notch may be provided on differing portions of the handle. When closed, the locking tab is received within the locking notch. The frictional engagement between the locking tab and the locking notch tends to retain the eating utensil in the closed position, until intentionally opened.

The hinge on the handle of the eating utensil has a thin flexible member that allows the two parts of the handle to pivot with respect to one another. The handle has a hinge tab disposed on one side of the hinge, and a hinge slot disposed on the other side of the hinge. The hinge tab is receivable within the hinge slot and maintains the handle in the extended position when the eating utensil is to be used. The hinge tab and slot are arranged and configured so when the eating utensil, such as a spoon, fork or spork, is used, the pressure applied to the top of the head by food tends to force the inner surface of the hinge slot against the hinge tab. In other words, when the eating utensil is extended, the hinge assembly is configured in such a way that normal use of the eating utensil works to keep the eating utensil in the extended position. Beyond that, the frictional engagement of the hinge tab against the hinge slot serves to keep the eating utensil in the extended position. When fully extended, the eating utensil has a length that is sufficient to allow a consumer to comfortably and conveniently consume the food item for which the eating utensil was supplied.

In one embodiment, the eating utensil can be folded in half to reduce its size for distribution and this folded structure can be incorporated into a plastic satchel 30 for convenient and sanitary distribution. In another embodiment, the plastic satchel 30 will contain a full size, non-folding eating utensil. In another embodiment, the plastic satchel 30 will contain a reduced size, non-folding eating utensil. Regardless of whether the eating utensil is foldable or non-foldable or whether it is full size or reduced size, each individual eating utensil is contained within a plastic satchel 30 and becomes part of a plurality of satchels 30 connected together as a bandolier 28 for loading into a dispenser 12. The dispenser 12 can be conveniently and unobtrusively mounted next to a food item display so the eating utensils are readily available to any patron desiring to acquire and consume the food item. Such a display can be placed proximate a point of sale to further convenience the consumer.

Embodiment of the present invention enable stores to provide a system that allows customers to try free samples of product prior to purchase without having to employ a person to distribute the free samples. As such, manufactures and retailers have may use the present system to provide free samples of food products that require utensils and/or seasoning/toppings for customers to try before buying.

Although the present invention has been described with reference to preferred embodiments, persons skilled in the art will recognize that changes may be made in form and detail without departing from the spirit and scope of the invention.

1. A method of providing a food item with an eating utensil, the method comprising:
providing a food display unit proximate a point of sale;
providing individual food items within the food display unit; and
associating a dispenser with the food display unit, wherein the dispenser is adapted to dispense eating utensils.

2. The method of claim 1 further comprising loading a plurality of eating utensils into the dispenser, wherein the eating utensils are in satchels and the satchels are interconnected to form a bandolier.

3. The method of claim 1, wherein the food display unit is a refrigerator unit.

4. The method of claim 1, wherein the food display unit is a freezer unit.

5. The method of claim 1, wherein the food display unit is heated.

6. The method of claim 1, wherein the food display unit is neither heated nor cool ed.

7. The method of claim 1, further comprising a associating a microwave oven with the food display unit.

8. The method of claim 1, wherein the eating utensils are spoons.

9. The method of claim 1, wherein the eating utensils are forks.

10. The method of claim 1, wherein the eating utensils are sporks.

11. The method of claim 1, wherein the dispenser is coupled with a shelf within the food display unit.

12. A method of providing a food item on the go, comprising:
providing a food display case proximate a point of sale, the display having at least one shelf;
stocking a food item within the display;
providing a dispenser coupled to the at least one shelf, wherein the dispenser includes a cavity and an opening.
providing a bandolier of individually wrapped eating utensils; and
storing the bandolier within the cavity so that a first end of the bandolier is fed through the opening so that the utensils can be dispensed.

13. The method of claim 12, wherein the food display case is a refrigerator unit.

14. The method of claim 12, wherein the food display case is a freezer unit.

15. The method of claim 12, wherein the food display case is heated.

16. The method of claim 12, wherein the food display case is neither heated nor cooled.

17. The method of claim 12, further comprising a associating a microwave oven with the food display case.

18. The method of claim 12, wherein the eating utensils are spoons.

19. The method of claim 12, wherein the eating utensils are forks.

20. The method of claim 12, wherein the eating utensils are sporks.

21. The method of claim 12, wherein the food item is yogurt.

22. A utensil dispenser comprising:
a housing;
a cavity within the housing for receiving a bandolier of individually wrapped items;
an opening through the housing in communication with the cavity; and
an attachment device for coupling the housing to a price shelf of shelving unit.

23. The spoon dispenser of claim 22, wherein the attachment device is a bracket.

24. The spoon dispenser of claim 22, wherein the attachment device is selected from the group consisting of screws and bolts.

25. The spoon dispenser of claim 22, wherein the attachment device is an adhesive.

26. The spoon dispenser of claim 22, wherein the attachment device is a magnet.

27. A system for providing food items in conjunction with eating utensils, the system comprising:
a food display unit proximate a point of sale, the display unit including a shelf for displaying the food items; and
a dispenser associated with the food display unit and including
a housing having an opening therethrough and a cavity in communication with the opening and adapted to receive a bandolier of individually wrapped eating utensils, wherein
the eating utensils are dispensed through the opening, and
an attachment device for coupling the housing to the display unit.

28. The system of claim 27, wherein the food display unit is a refrigerator unit.

29. The system of claim 27, wherein the food display unit is a freezer unit.

30. The system of claim 27, wherein the food display unit is heated.

31. The system of claim 27, wherein the food display unit is neither heated nor cooled.

32. The method of claim 27, further comprising a microwave oven associated with the food display unit.

33. A method for dispensing food packets for use with a food product on the go, comprising:
providing a food display case proximate a point of sale, the display having at least one shelf;
stocking a food product within the display;
providing a dispenser coupled to the at least one shelf, wherein the dispenser includes a cavity and an opening.
providing a bandolier of individually wrapped food packets; and
storing the bandolier within the cavity so that a first end of the bandolier is fed through the opening so that the food packets can be dispensed.

34. The method of claim 33, wherein the act of providing a bandolier of individually wrapped food packets include providing food packets containing a seasoning.

35. The method of claim 33, wherein the act of providing a bandolier of individually wrapped food packets include providing food packets containing a topping.

36. A method for providing free samples of a food product prior to purchase of the product, comprising:
providing a food display case, the display having at least one shelf;
stocking free samples of the food product within the display;
providing at least one dispenser coupled to the at least one shelf, wherein the dispenser includes a cavity and an opening.
providing at least one bandolier, with each of the at least one bandolier including one of utensils or food packets; and
storing the at least one bandolier within the cavity so that a first end of the bandolier is fed through the opening so that the one of the utensils or food packets can be dispensed.

37. The method of claim 36, wherein the act of providing free samples includes providing a quantity of food product consistent the objective of enabling a customer to appreciate the taste of the food product sold.

38. The method of claim 37, wherein the act of providing at least one dispenser, includes providing two dispensers.

39. The method of claim 38, wherein the act of providing a bandolier includes providing one bandolier with utensils and one bandolier with food packets.
